(19) United States
(12) Patent Application Publication
(10) Pub. No.: US 2022/0139572 A1
(43) Pub. Date: May 5, 2022

(54) VETERINARY SERVICES SYSTEM AND METHOD

(71) Applicant: VetNow, LLC, Canonsburg, PA (US)

(72) Inventors: Apryle Horbal, Pittsburgh, PA (US); Evan Kelly, Pittsburgh, PA (US); Tyler Carraway, New Eagle, PA (US); Daniel Farquhar, Monongahela, PA (US)

(21) Appl. No.: 17/564,005

(22) Filed: Dec. 28, 2021

Related U.S. Application Data
(63) Continuation of application No. PCT/US2020/004020, filed on Jun. 29, 2020.
(60) Provisional application No. 62/868,481, filed on Jun. 28, 2019.

(51) Int. Cl. G16H 80/00; G16H 40/20

(52) U.S. Cl. CPC G16H 80/00; G16H 40/20

(57) ABSTRACT

In accordance with aspects of the inventive concepts, provided are a veterinary services system and method, in the form of an online platform that provide a full spectrum of veterinary services via a virtual clinic collaborative tool. The platform enables remote consultations in a seamless and secure environment between patients, owners, and veterinarians and allows for the sharing and collaboration of clinical data between all parties involved. The platform enables veterinarians to see patients/owners in any clinical setting, including a virtual care setting. Providers can collaborate in real-time, virtually using video functionality supported by the platform.

### CROSS REFERENCE TO RELATED APPLICATIONS

The present application is a continuation of International Application No. PCT/US2020/04020 filed Jun. 29, 2020, entitled VETERINARY SERVICES SYSTEM AND METHOD, which claimed priority under 35 USC 119(e) to U.S. Provisional Applicant No. 62/868,481, entitled VETERINARY SERVICES SYSTEM AND METHOD, and filed on Jun. 28, 2019; the contents of each are incorporated herein by reference in their entirety.

### FIELD OF INTEREST

The present inventive concepts relate to the field of computer-based veterinary systems and methods, and more particularly to systems and methods used to processes veterinary information and to manage veterinary patient care, including virtual patient care.

### SUMMARY

In accordance with one aspect of the inventive concepts, provided are a veterinary services system and method, in the form of an online platform that provides a full spectrum of veterinary services via a virtual clinic collaborative tool and/or system. The platform enables remote consultations in a seamless and secure environment between owners of pets and other animals and/or veterinarians and allows for the sharing and collaboration of clinical data between all parties involved. The platform enables veterinarians to interact with patients (e.g., pets and other animals) and their owners (e.g., clients) in any clinical virtual care setting. A patient can be any type of animal, such as mammals, reptiles, fish, birds, and amphibians. For a veterinary standpoint, humans are not patients. The platform enables veterinary professionals from multiple locations to collaborate in real-time in the care, diagnosis and/or treatment of a patient.

A veterinarian (provider) and enlist the assistance of one or more veterinary specialists in the diagnosis and treatment of an animal. The veterinarian can control, electronically, the enlistment of a specialist from among a number of specialists registered with and/or listed within with platform.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is an embodiment of a veterinary services system, in accordance with aspects of the inventive concept;

FIGS. 2-1 through 2-17 show embodiments of client and provider screens generated by the system of FIG. 1, in accordance with aspects of the inventive concept;

FIG. 3A shows an embodiment of a client-user account creation process, in accordance with aspects of the inventive concept;

FIG. 3B shows an embodiment of a process for client-user use of the platform, in accordance with aspects of the inventive concept;

FIG. 3C shows an embodiment of a process for login to the platform, in accordance with aspects of the inventive concept;

FIG. 3D shows an embodiment of a process for client-user interaction with the platform, in accordance with aspects of the inventive concept;

FIG. 3E shows an embodiment of a process for how a client-user requests urgent care within the platform, in accordance with aspects of the inventive concept;

FIG. 3F shows an embodiment of a process for how a provider-user, e.g., a veterinary clinic, interacts with the platform, in accordance with aspects of the inventive concept;

FIG. 3G shows an embodiment of a process for how a provider-user, e.g., a clinician, interacts with the platform, in accordance with aspects of the inventive concept;

FIG. 3H shows an embodiment of a process for providing a virtual care appointment using the platform, in accordance with aspects of the inventive concept; and

FIGS. 4-1 and 4-2 collectively provide an example of a class diagram that could be used to implement some of the functions of the modules of the platform in computer program code.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concepts may, however, be embodied in many different forms and should not be construed as limited to the exemplary embodiments set forth herein.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

Embodiments of the veterinary services platform provide a new global veterinary standard of care by creating access to personalized treatment at a reduced cost via a virtual care platform, and continuing to advance the veterinary profession through continued education, training, and discovery. The platform improves access to high quality care for animals and their owners, from household pets to livestock. The platform improves client retention and reduces costs to clients, while improving the standard of care.

In accordance with aspects of the inventive concepts, provided are a veterinary services system and method that enable cloud-based virtual veterinary care. The system can take the form of an online platform having a plurality of modules, e.g., executable program code, that enables veterinary service providers and clients to cooperatively engage in the virtual healthcare of animals. The platform enables remote consultations in a seamless and secure environment between patients (e.g., pets and other animals), owners (e.g., clients), and/or veterinarians (providers) and allows for the sharing and collaboration of clinical data between all parties involved. The platform enables veterinarians to see and interact with patients/owners in any clinical setting. As an example, the platform enables veterinary professionals to collaborate virtually, over a computer network, in real-time to diagnose and/or treat a patient, e.g., evaluate a patient's symptoms and condition, perform a surgery, and/or otherwise treat a patient. A veterinary provider can enlist the assistance of a specialist from a plurality of specialists in a plurality of veterinary disciplines.

In some embodiments, the platform can register a plurality of veterinary clinics, each having one or more associated veterinary providers. Each clinic and its veterinarians can manage their practice through and within the platform. Each clinic and/or veterinarian can register and/or associate, within the platform, with one or more specialists as preferred providers with respect to a variety of medical disciplines. More globally, the platform can have established accounts for a number of specialists that clinics and/or veterinarians can utilize as needed, e.g., if one of their own specialists is not available.

When a client accesses the platform and requests an appointment with its veterinary clinic and/or provider, the provider uses the platform to select and schedule a specialist, if needed. The provider, therefore, could bill the client for the specialists through its own practice and effectively extend its offerings to its clients without employing the specialist(s). In this way, the provider provides a broader spectrum of services to its clients, with a depth of knowledge in a number of specialists that is otherwise difficult, if not impossible, to achieve.

In various embodiments, the platform can electronically enable a rich set of features, including electronic medical records (EMR) integration, e-prescriptions, virtual waiting rooms, self-scheduling, pre-visits questionnaires, and post-visit surveys, as examples.

The EMR integration feature can enable integration with top EMR systems and sources, providing immediate access and updates to medical information in real-time. The e-prescription feature can enable prescribers to electronically send a new prescription or a renewal authorization to patients and/or pharmacies. The virtual waiting room feature gives patients (e.g., pets and other animals) and their owners (clients) the experience of being in a virtual office with the convenience of seeing a veterinarians and specialist remotely, at virtually any time. A self-scheduling feature enables both veterinarians and owners/clients to schedule their telehealth visits online and update them at any time.

There are several benefits to clients, providers, and specialists. For general veterinary providers, the platform preferably enables immediate access to specialists (e.g., one of a predetermined set of “panelists”), allows an increase in revenues without a substantial increase in costs, clinic practice managers can build a business model, and the provider can stay ahead of market trends and innovation to efficiently offer new services to clients. Specialists can benefit because they can be a part of a demanding market trend and innovation, flexible work schedules, build their own virtual health clinic, consult on clinical workflows and provide second opinions, mobile access for convenience, monetizing time (e.g., supports doctor-to-doctor consults), and extend their practices beyond their geographic footprint. Also, providers and specialists can get paid more quickly via electronic transactions.

In various embodiments, the platform includes technology (e.g., computer program code, processors, data storage devices, communication technology, and input/output devices, etc.) that enables veterinarians to provide or assist in providing a plurality of veterinary services by networking together specialists in any know medical discipline, including one or more of the following:
Cardiology: A board certified veterinary cardiologist has advanced training and knowledge of the heart and circulatory systems. Focusing on the diagnosing and treatment of heart and lung abnormalities and diseases, a boarded cardiologist can work to help pets live longer, healthier lives.
Critical Care: The scope of veterinary emergencies varies greatly. The platform provides access to 24-hour emergency veterinarians that see everything from animals (including pets) that are uncomfortable due to itching or mild illness to animals that are critically ill or injured.
Dentistry: Veterinary dentistry is the art and science of prevention, diagnosis, and treatment of conditions, diseases, and disorders of the oral cavity, the maxillo-facial region, and its associated structures as it relates to animals.
Dermatology: There are many dietary, allergic, and internal diseases in animals that manifest with ear and skin abnormalities. Veterinary dermatologists have extensive training to diagnose and treat these underlying conditions and bring relief to animals who are suffering.
Emergency Room (ER) Triage: The platform can be used to provide comprehensive 24-Hour Emergency & Critical Care triage.
Equine: Equine specialty practitioners are trained in the biological structures of horse breeds. Equine specialists are extensively trained to tend to the specific needs of different parts of a horse, while knowing the potential causes of apparent issues.
Exotics: Exotics animals can still be household creatures, as pets. Any animal from a rabbit to a bird is considered an exotic animal. These exotic animals need different care than the dogs and cats more traditionally found in homes.
Internal Medicine: Internal medicine specialists use their training and experience to work with veterinarians to determine the cause of an animal's ailment. They typically help to diagnose, treat, and manage chronic conditions.
Neurology: Board Certified Neurologists are specially educated about conditions afflicting the brain, spinal cord, nerves, and muscles.
Oncology: Veterinary Oncologist diagnose and treat cancer in animals. The platform can enable the provision of veterinary oncology services, such as reaching a definitive diagnosis as efficiently and quickly as possible.
   The myriad specialties that can be provided via or using the platform includes, but is not limited to, those listed in Appendix A, which forms part of this specification.

In various embodiments, the platform can comprise a one or more servers executing veterinary computer program code. Mobile devices, such as mobile phones, can access the platform to utilize virtual veterinary functionality. With respect to a mobile device, a mobile device processor and storage may be used, e.g., as part of or an extension of the virtual veterinary platform. Plural mobile phones, laptops, tablets, phablets, desktop computers, and servers can interface with and/or form part of the virtual veterinary platform.

In some embodiments, a virtual veterinary application can be loaded on a mobile phone to enable communication and information exchange with the virtual veterinary platform. In various embodiments, various functionalities, such as appointment scheduling, virtual appointments, messaging, notifications, and billing, as examples, can be accessible via the application on a client's mobile phone or other device. Additionally, or alternatively, in various embodiments, various informational, business, diagnostic, collaboration, and treatment functionality can be accessible via the application on a veterinary professional's mobile phone or other device.

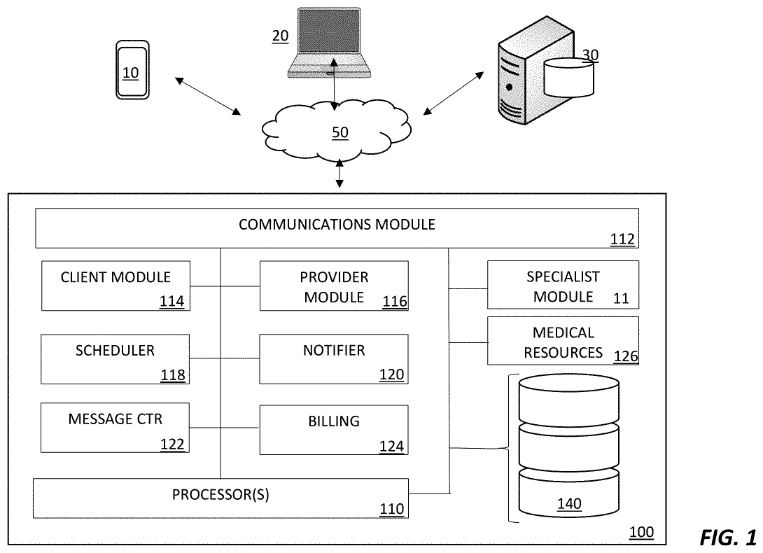

FIG. 1 is an embodiment of a virtual veterinary system or platform, in accordance with aspects of the inventive concepts. Referring to the embodiment of FIG. 1, the platform 100 can be accessible over the Internet, Worldwide Web, or other networks, whether wired, wireless, or a combination thereof. The networks are collectively represented by cloud 50. The platform may be configured to interface, communicate, and exchange information with several different types of devices and/or systems, such as mobile devices 10 (e.g., tablets, phablets, and/or mobile phones), desktop or laptop computers 20, server-based systems or databases 30, other systems, such as smart televisions, smart speakers, and the like, that can present to and/or receive veterinary service data and information via such devices.

The platform 100 and the external systems 10, 20, and 30 can exchange a wide variety of information, such as information related to the patient (e.g., pet or animal), client, providers, specialists (or panelists), and medical training, diagnosis, and/or treatment. The information can be information related to appointment scheduling, billing, diagnosis, prescriptions, and/or treatment. A user of the external devices can be, as examples, one or more of a client, provider (e.g., doctor, clinic, or hospital), specialist, consultant, emergency personnel, insurance provider, pharmacy, bank or other financial institution, medical information source, and so on.

As represented in FIG. 1, the platform 100 includes at least one processor 110 having access to at least one data storage device or system 140 and a plurality of executable functional modules. The processor(s) 110 can be any now known or later developed form of processor and the data storage device or systems 140 can be any now known or later developed form of data storage device or system.

In various embodiments, the plurality of functional modules can include one or more communications modules 112 comprising the necessary hardware, firmware, and/or software to enable various types of now known or later developed wired or wireless communications technology, e.g., local wireless (or WiFi) technology, Bluetooth, GPS technology, cellular telephone technology, Ethernet technology, coaxial technology, fiber optic technology, and so on. The present invention is not limited to any particular type of communication technology or medium.

The communication module 112 can facilitate communications between the platform 100 and external systems 10, 20, 30 or other systems not explicitly mentioned. The communication, in some instances, will be a client and at least one provider and/or at least one specialist, such as a veterinarian and specialist collaborating providers from different external devices 10, 20, 30 communicating via the platform 100. The communication, in some instances, will be a veterinarian and at least one specialist collaborating on the diagnosis and/or treatment of an animal from different external devices 10, 20, 30 communicating via the platform 100. In such cases, cameras, microphones, and other imaging equipment can be used at the animal's location to enable at least one provider and specialist to collaborate. Output devices at the animal's site can include displays, printers, and speakers, as examples.

Returning to FIG. 1, a client module 114 can be configured to setup client accounts and manage client information, including the setup and maintenance of a client profile, which can be stored in the data storage system 140. In addition to client identification and contact information, the client module 114 can be used to identify each pet or animal associated with the client, and the client's chosen clinic and/or veterinarian. For each pet or animal, there can be a database of medical history and other related information accessible by the client's clinic and/or veterinarian. The client module 114 can include client user interface functionality that generates the user interface screens output at one or more of the external devices 10, 20, 30. In some embodiments, the client screens can include a client dashboard as a landing page for a client once logged in to the platform 100. The dashboard can provide a plurality of navigable options with different types of information related to the client and its pets.

In FIG. 1, a provider module 116 can be configured to manage provider information, e.g., where the provider is a veterinary clinic having one or more veterinarians. The module 116 can include setup and maintenance of a provider profile, which can be stored in the data storage system 140. In addition to provider identification and contact information for the clinic, the provider module 116 can be used to identify each veterinarian in the clinic's practice and any areas of specialty, medical credentials, affiliations, and/or client ratings or testimonials, as examples. The module 116 can enable the practice of the clinic and veterinarian to invite, list and/or register their clients. The provider module 116 can include provider user interface functionality that generates the user interface screens output at one or more of the external devices 10, 20, 30. In some embodiments, the provider screens can include a provider dashboard as a main landing page for the provider (including its veterinarians) once logged in to the platform 100. The dashboard can provide a plurality of navigable options with different types of information related to the provider and its client and its clients' pets.

A specialist module 117 can be configured to manage specialist information. The module 117 can include setup and maintenance of a specialist profile, which can be stored in the data storage system 140. In addition to specialist identification and contact information, the specialist module 117 can be used to identify areas of specialty. The module 117 can enable the provider to access its information and schedule for appointment scheduling to provide services to a client of the provider. The specialist module 117 can include specialist user interface functionality that generates the user interface screens output at one or more of the external devices 10, 20, 30. In some embodiments, the specialist screens can include a specialist dashboard as a main landing page for the specialist once logged in to the platform 100. The dashboard can provide a plurality of navigable options with different types of information related to the specialist and its appointments.

Returning to FIG. 1, a scheduler module 118 allows client to login and electronically schedule, change, and cancel appointments. The appointments can be requested for a specific provider or for a specific type of specialist, or for a generalist. The request for an appointment can be for a virtual appointment (e.g., via computer interface), for an in-person visit, or the appointment type could be left unspecified. Preferable, the client submits a request for an appointment with its provider. If a specialist is needed, the provider determines that needs and schedules an appointment between the client and specialist.

The scheduler module can create a virtual waiting room associated with appointments. When an appointment is schedule, the client logs in for the appointment and can enter the virtual waiting room. The provider and/or specialist can receive an electronic notification that the client is in the virtual waiting room. The provider and/or specialist can then admit the client and commence the appointment.

The platform 100 can further include a notifier module 120 that can include functions to send notifications to the provider and/or client associated with the healthcare of the client's pet or animal, including information about appointments, diagnoses, and/or treatments. The notifications can include, but are not limited to, a notification to a provider and/or an administrator of a client's request for an urgent care virtual appointment, a notification to a provider and/or an administrator of a client's request for a regular appointment, whether in-person or virtually, a notification to a provider and/or an administrator of a new client message, an alert of a provider communication, a notification to a client of readiness of an e-proscription, and so forth. The notifications can be provided via text message, initiation of a chat session, a pager message, an email, and/or a phone call, such as an automated call, as examples.

A message center module 122 can be provided to manage messaging between clients, providers, and/or specialists. As examples, in some embodiments, the message center can enable the generation of messages relating to client questions via electronic message and the forwarding or alerting to a provider and/or an administrator of a new or pending client message. The message center can also provide electronic messaging capability to enable the provider and/or administrator to respond to the client with an electronic message. The message center module 122 can function as an email messaging system with inboxes, sent folders, and other folders, as examples. The message center can be used to administer pre-visit questionnaires and post-visit surveys.

The platform 100 can include a billing module 124 that manages an electronic billing and payment service. Like other modules described herein, the billing module can be native to the platform 100 or a third-party resource utilized by the platform, which could be external systems in various embodiments. The billing module 124 can interface with credit card systems, banks, and credit unions to perform payment processing.

A medical resources module 126 can enable and manage all virtual sessions between clients, providers and/or specialists. For example, a client can have a virtual appointment with one or more providers and/or specialists. As another example, one or more providers and/or specialists can collaborate virtually over the Internet in the conduct of a medical diagnosis or treatment, or otherwise to share medical information. The medical resources module 126 can access and/or interface with documents, video tutorials, training materials, and the like within data storage system 140 or within external systems 10, 20, or 30, or some combination thereof. The medical resources module 126 can manage virtual appointment sessions, managing multiple input and output devices.

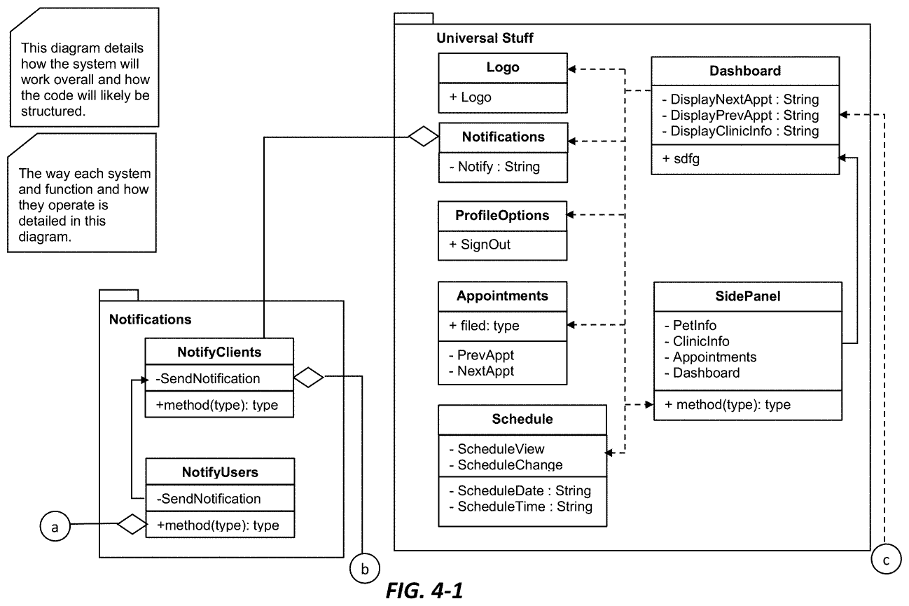

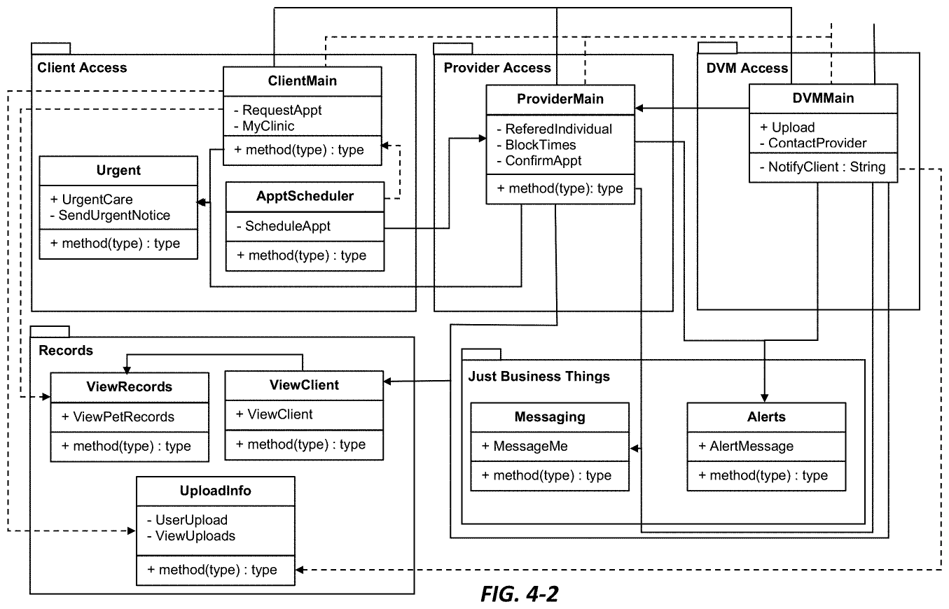

FIGS. 2-1 through 2-7 show embodiments of client screens that can be generated by the client module 114 of the platform 100, as an example. The client screen 200 has a structure that facilitates ease of use and navigation by the client (animal owner), as a computer user. It includes icons and selectable links that make accessing information and functionality of the platform 100 intuitive and efficient for the user. As such, the user's experience is enhanced and a wide variety of information is made readily available. Because of its efficient and logical structure and organization, less computer and user resources are wasted through long and complicated user-interactive sessions with the platform 100.

In this embodiment, the client screen 200 includes a menu portion 210 on the left side of the main portion 212. The main portion 212 can be structured to present information and functions in logical groups that enhance the ease of use by the user. In some embodiments, the main window can include one or more regions, each region comprising a logical grouping of information and functions. Information and functions in one region can be related to information and functions in another region within the main portion 212. As an example, in some embodiments, selection of a function and/or information in one region can cause responsive changes to information and/or functions in another region.

The menu portion 210 can take different forms or include different menu options. For example, in this embodiment, the menu options include Dashboard, Appointments, My Clinic, My Pets, Messages, Emergency, Financial Records, My Profile, and Help options. In other embodiments, different names and/or functions can be used. Selection of one of these options causes responsive displays of one or more regions within main portion 212.

In preferred embodiments, the information in the regions of the main portion 220 are user-specific and made available based on a valid login of a user. The login can require use of associated types of authentication technologies, including two-factor authentication. The upper righthand corner of the main portion 212 indicates that a user is logged in, here the user is “Patient.”

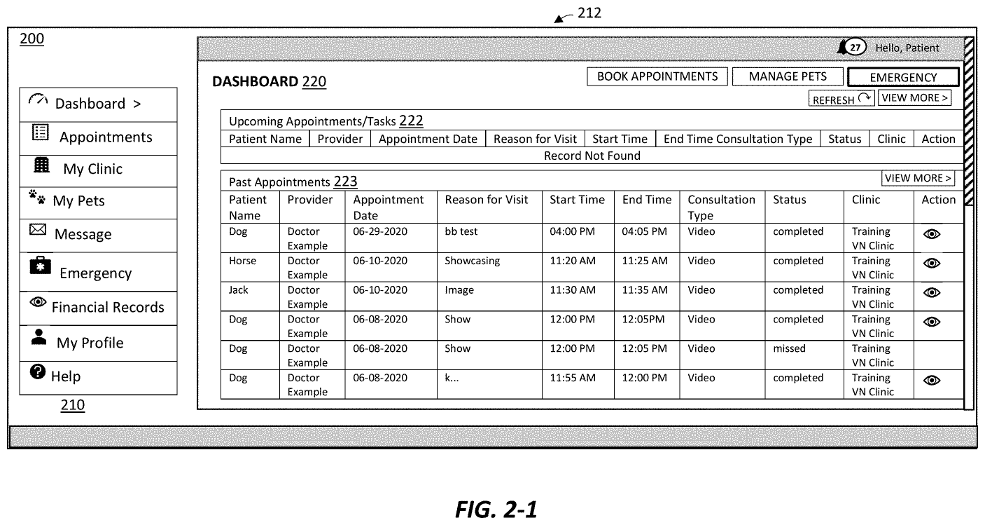

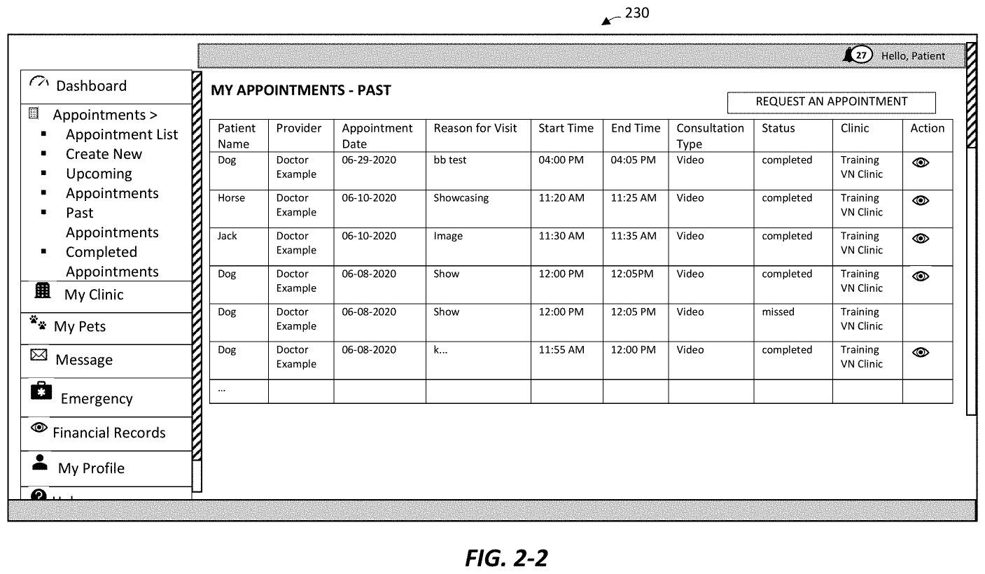

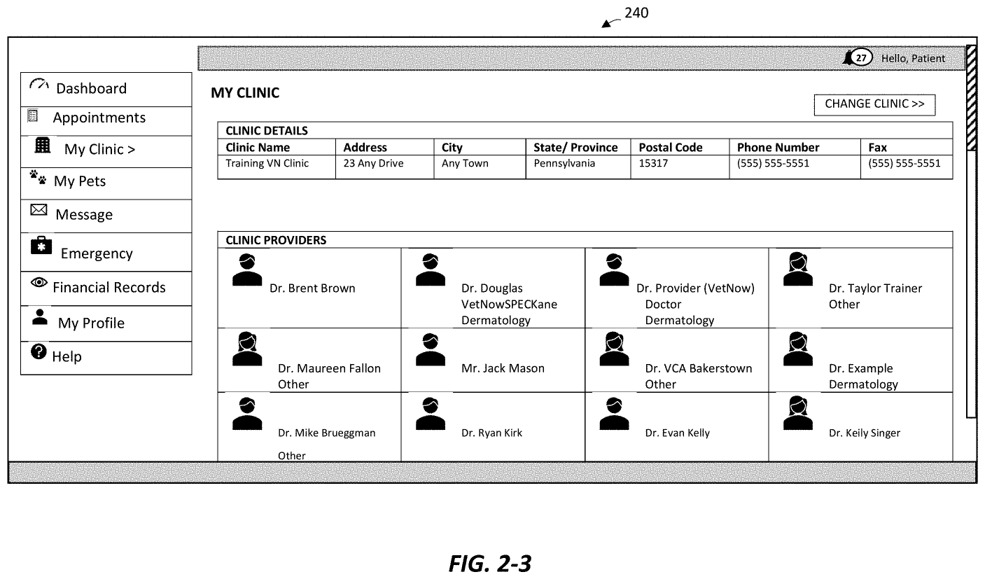

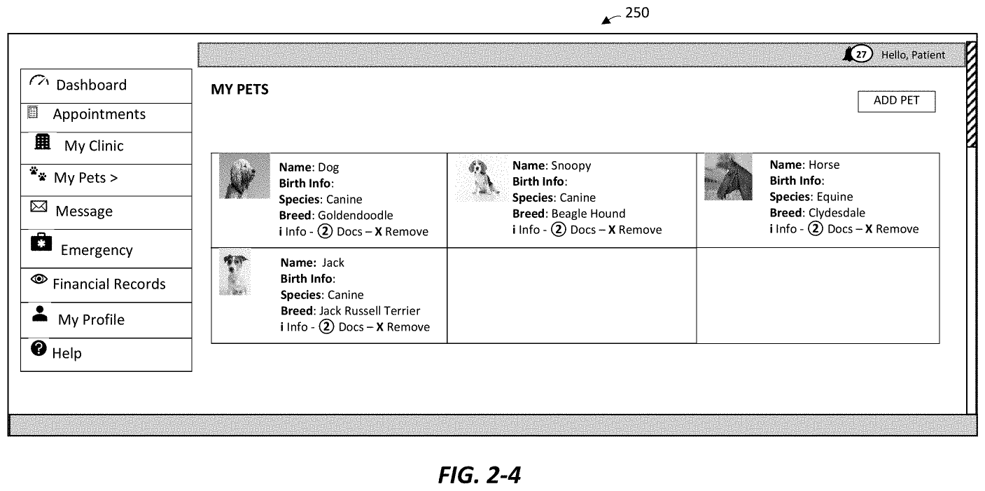

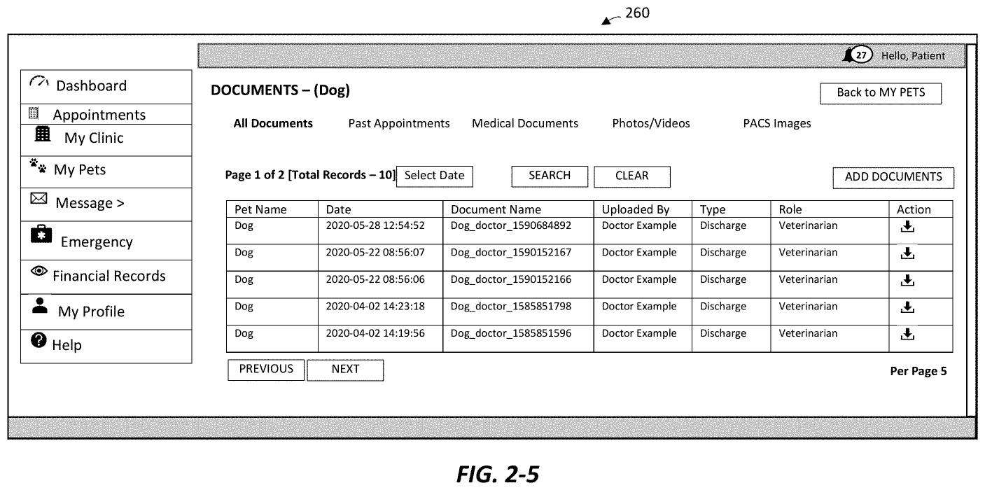

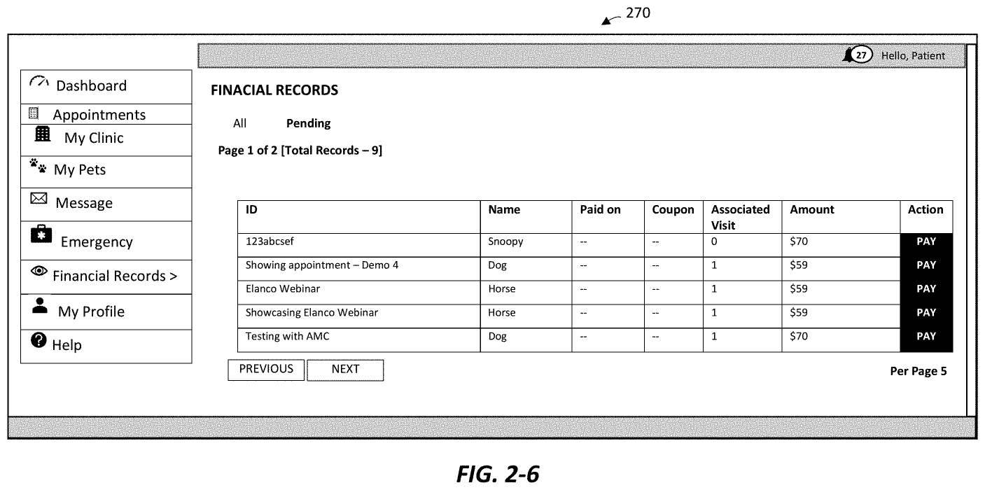

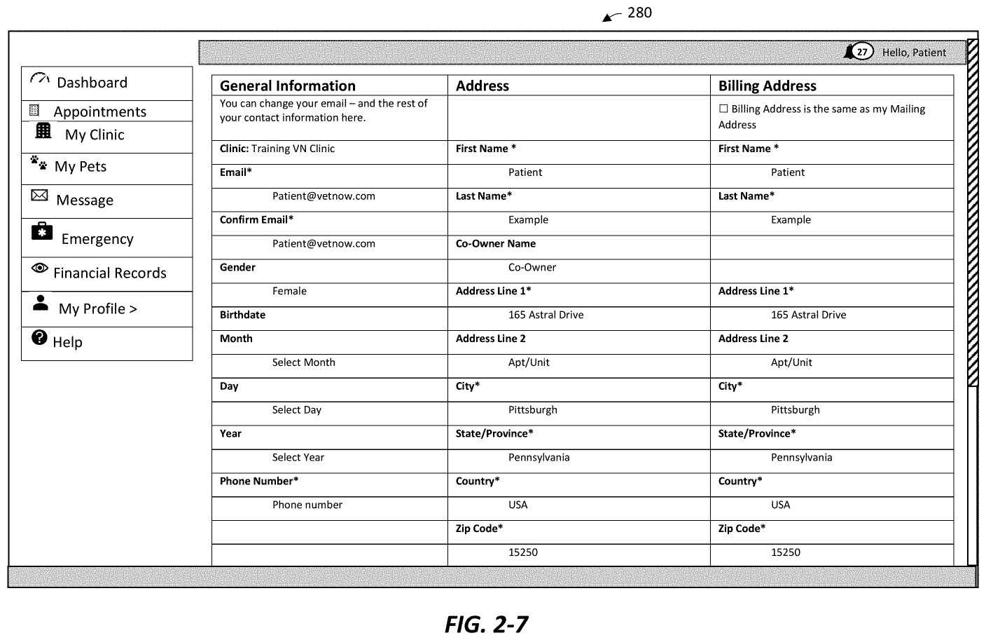

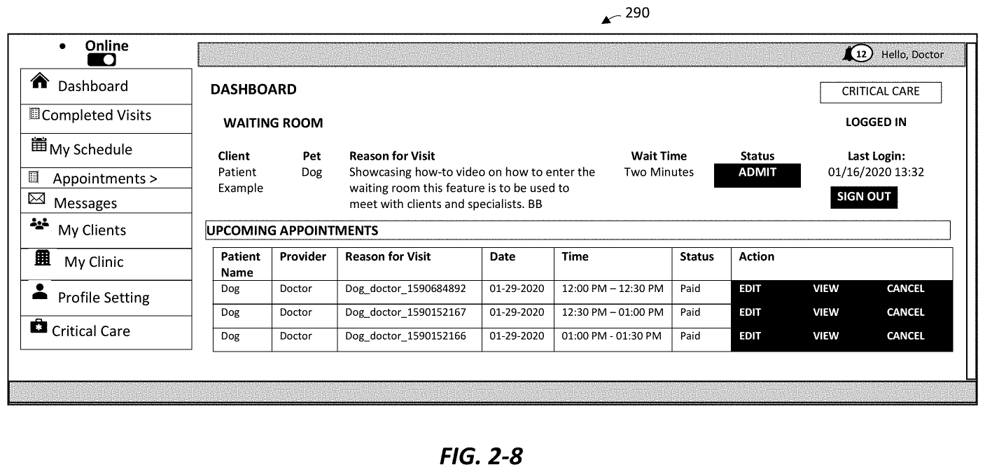

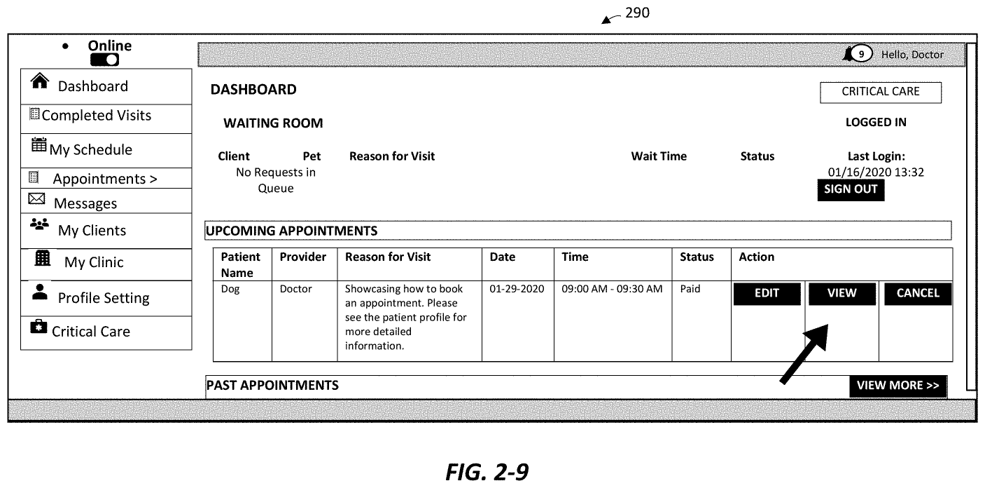

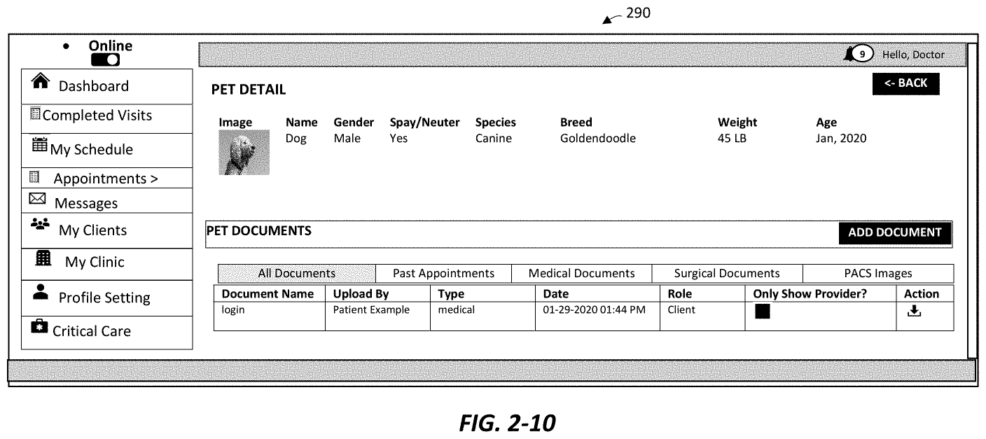

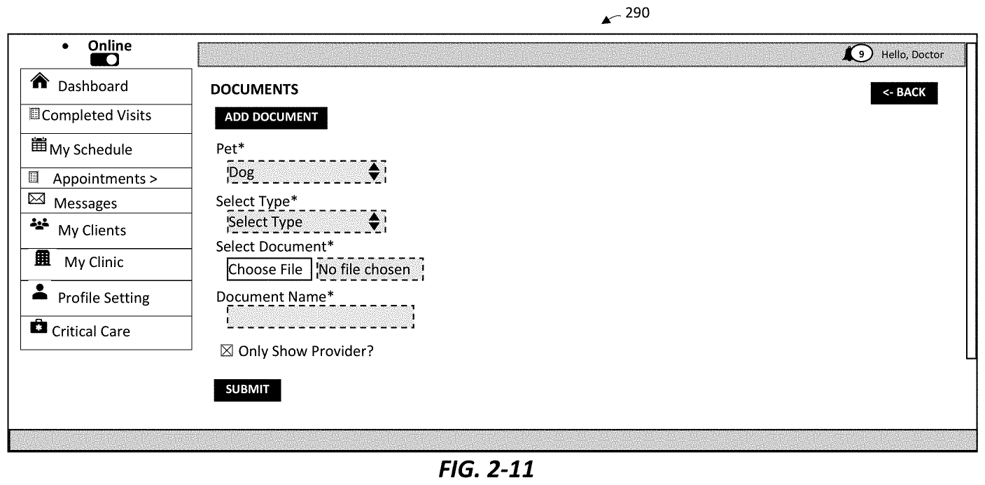

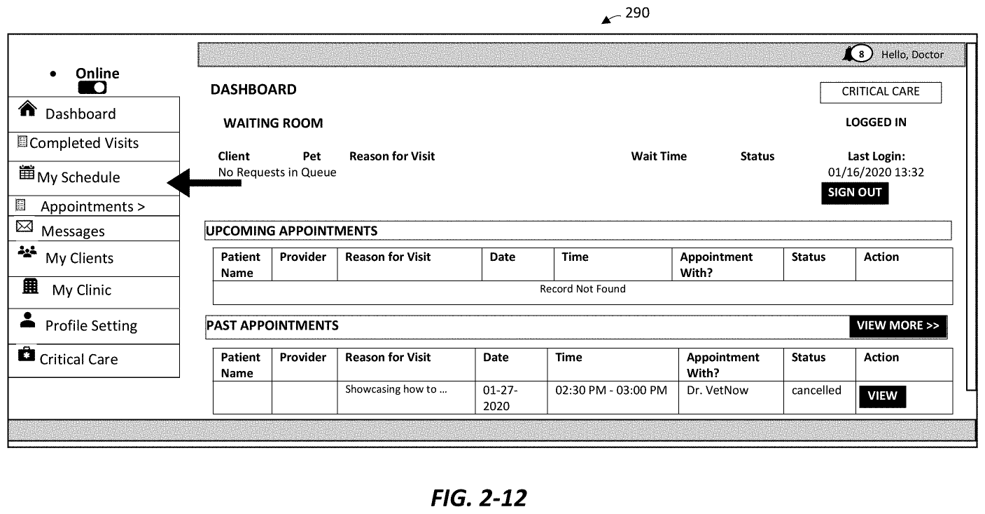

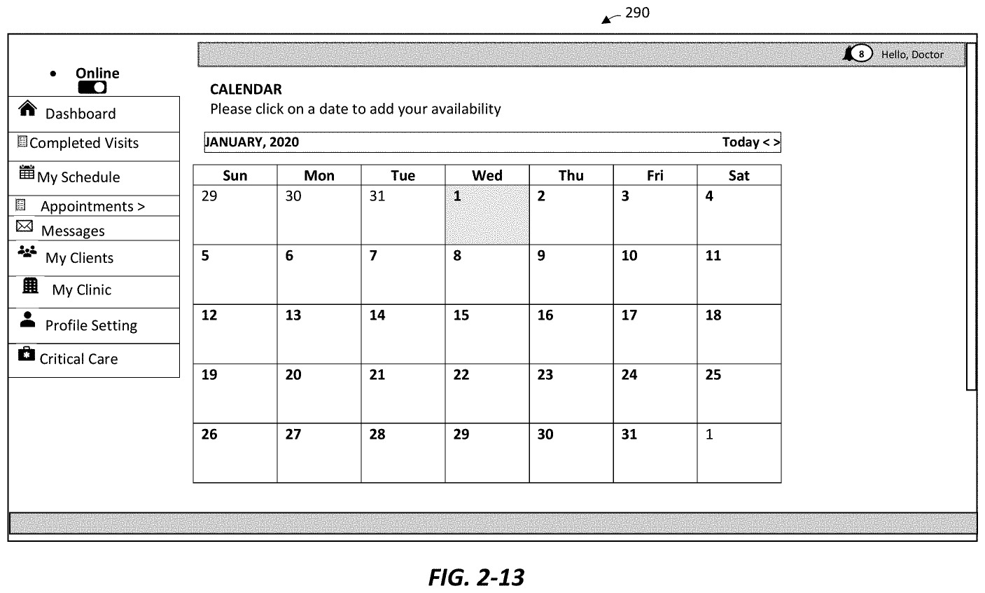

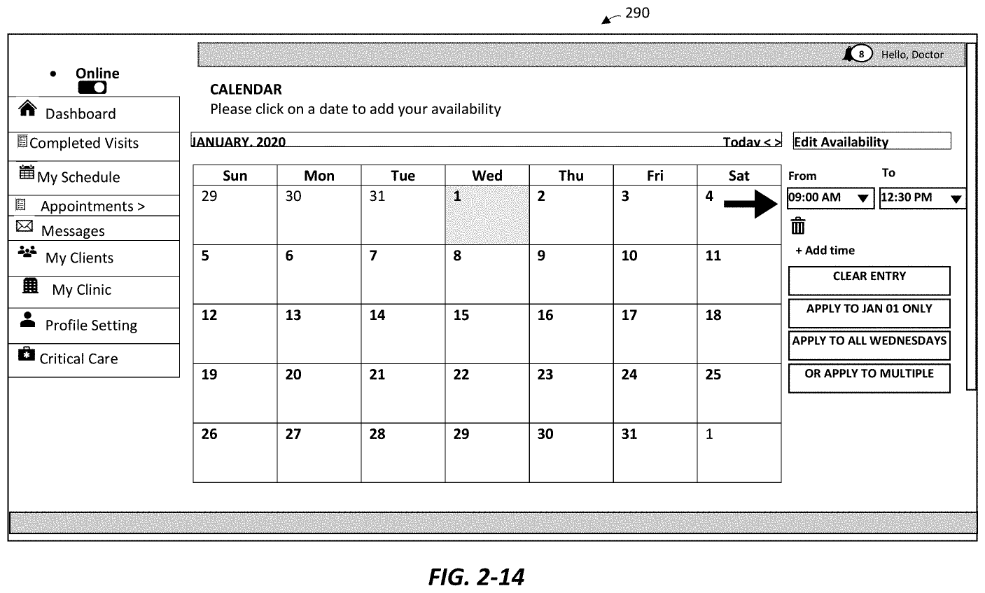

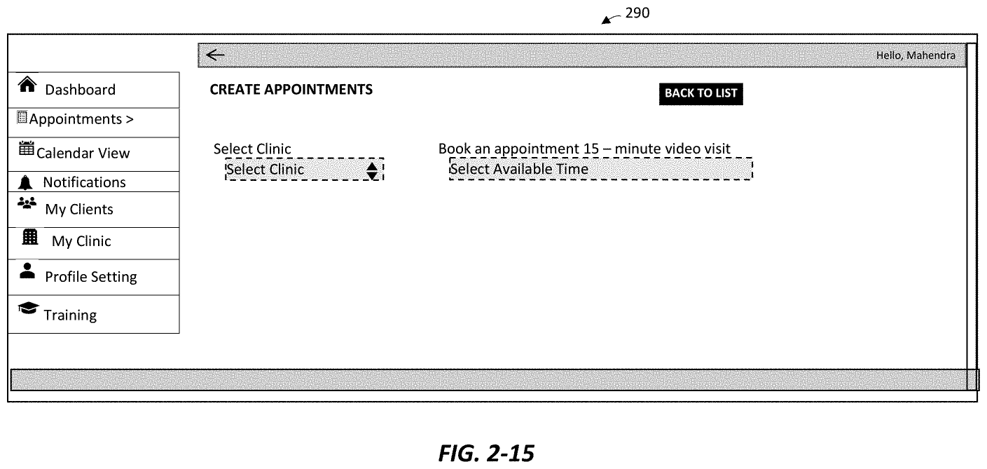

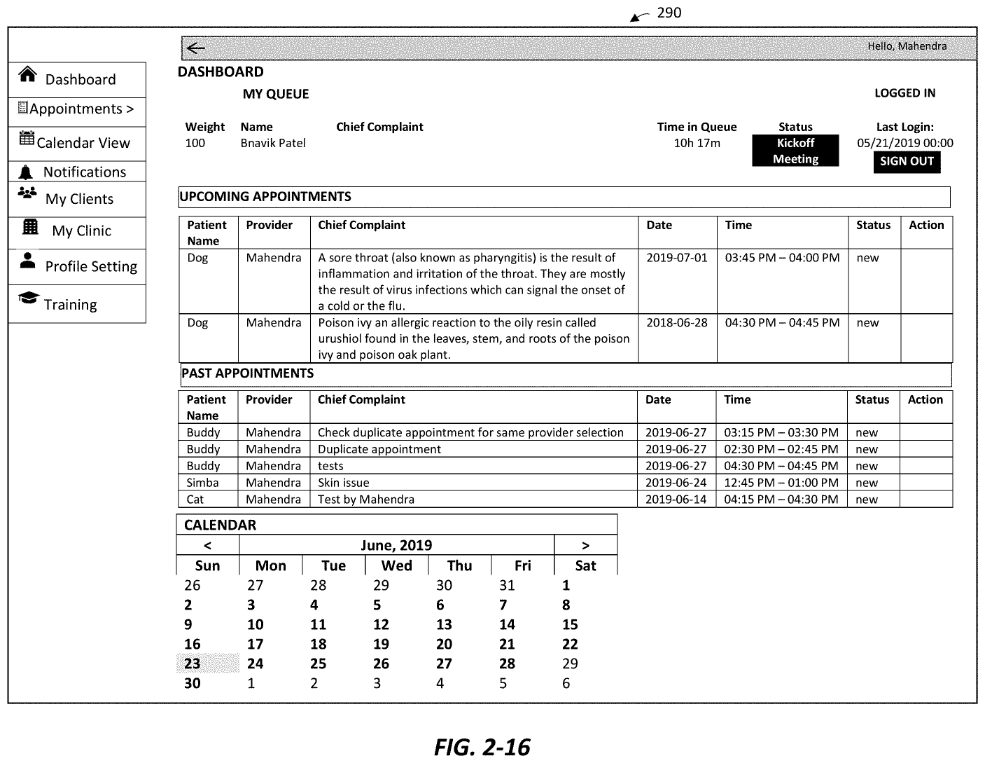

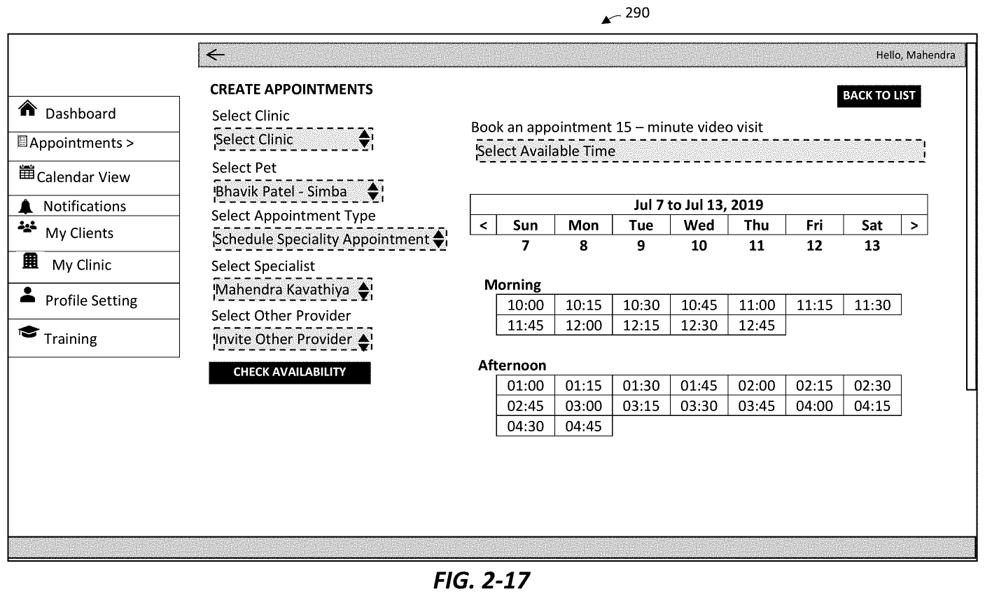

In FIG. 2-1, the Dashboard option has been selected from the menu portion 210 causing the Dashboard window 220 to be displayed in the main portion 212. In this embodiment, the Dashboard window 220 includes several regions. Across the top is an Upcoming Appointments region 222, which includes a list, in table form, of upcoming appointments for the client's (user's) pets. Here, there are no upcoming appointments shown. The Dashboard window 220 also includes a Past Appointments region 223, listing past appointments for this client's pets. Here, the pet's names are Dog, Horse, and Jack. Details are provided for each appointment, e.g., Patient Name, Provider, Appointment Date, Reason for Visit, Start and End Times, Consultation Type, Status, Clinic name, and Action. Other embodiments could use other types of information.

The screen also includes options labelled Book Appointment, Manage Pets, and Emergency (for scheduling urgent appointments).

FIG. 2-2 is an embodiment of a screen 230 displayed when the Appointments option is chosen from menu 210. Since there are no appointments pending, the screen merely lists past appointments. Screen 230 also includes a Request an Appointment option enabling the client to request a new appointment.

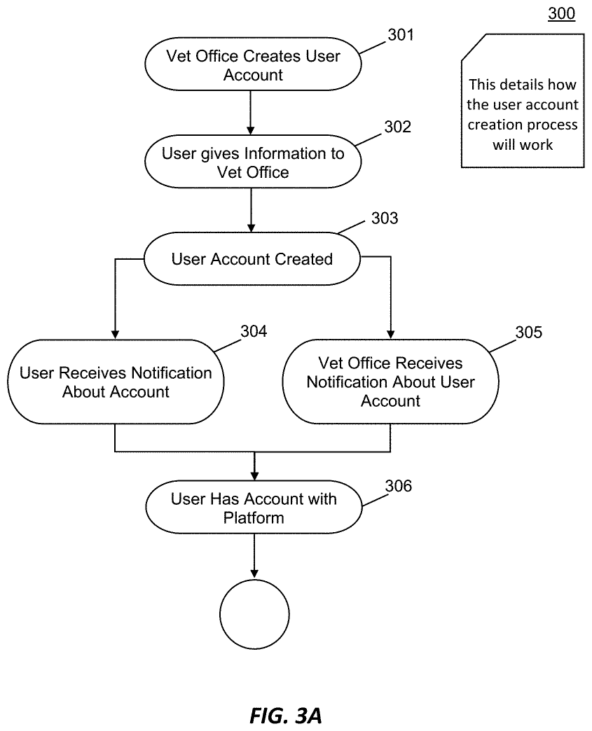

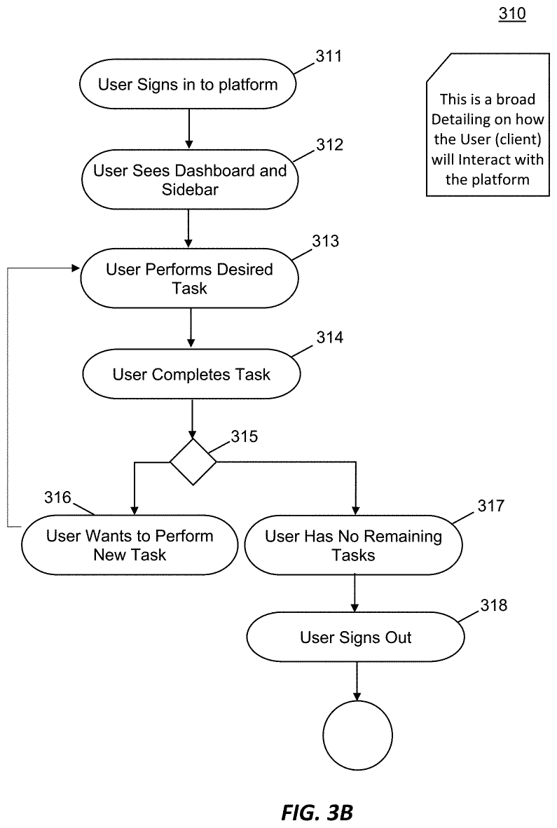

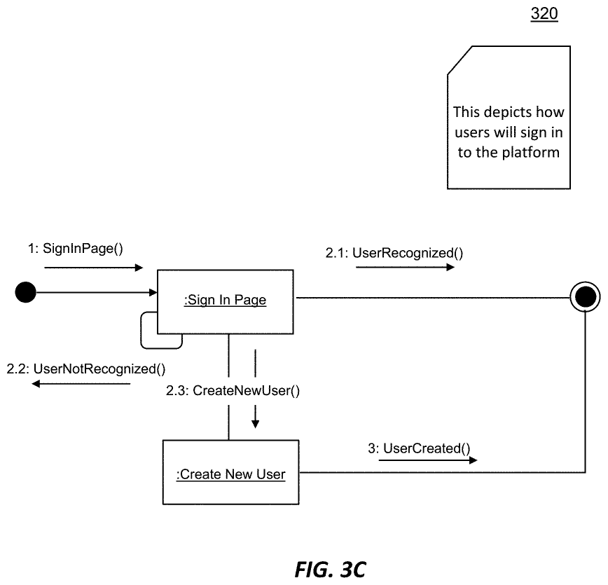

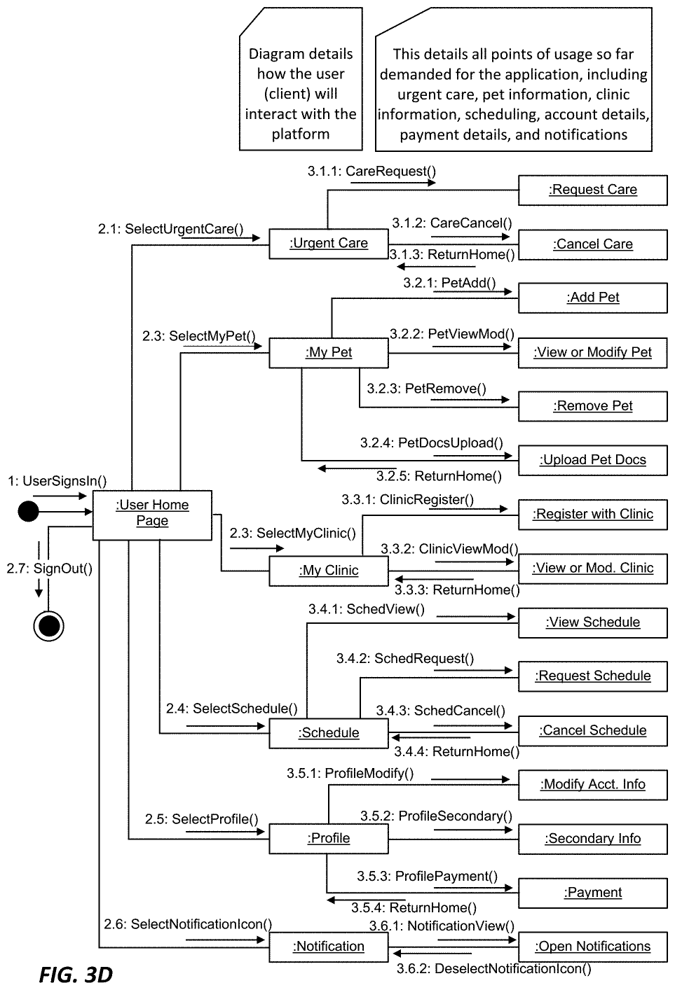

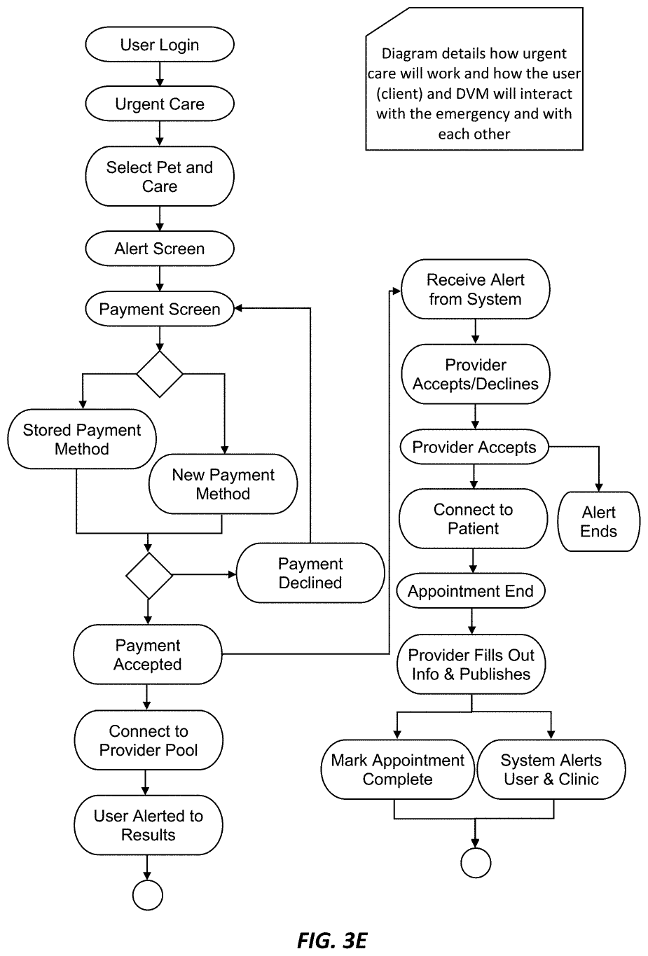

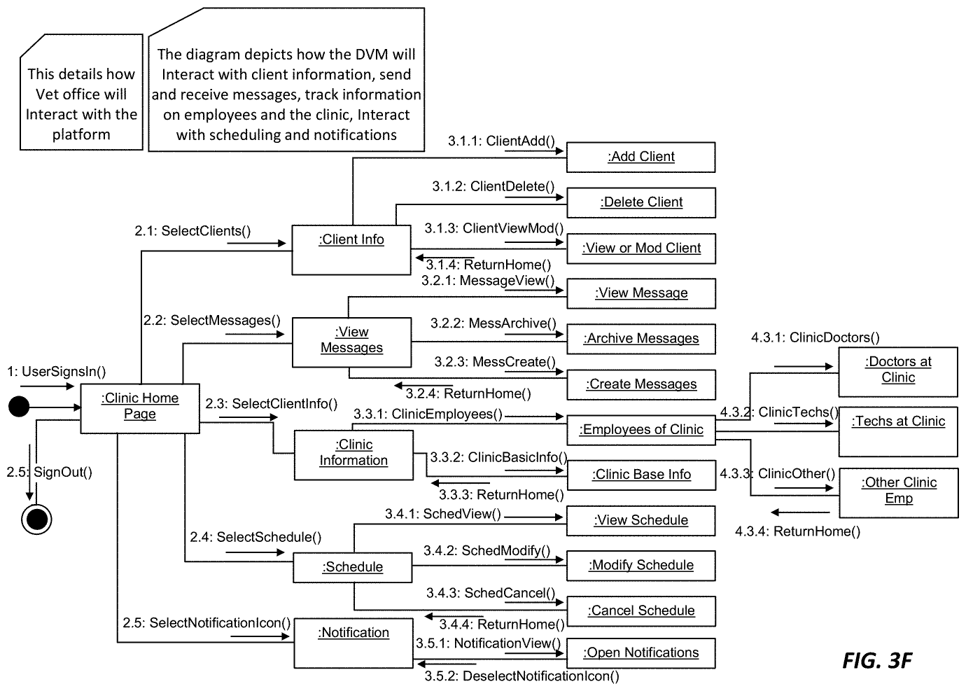

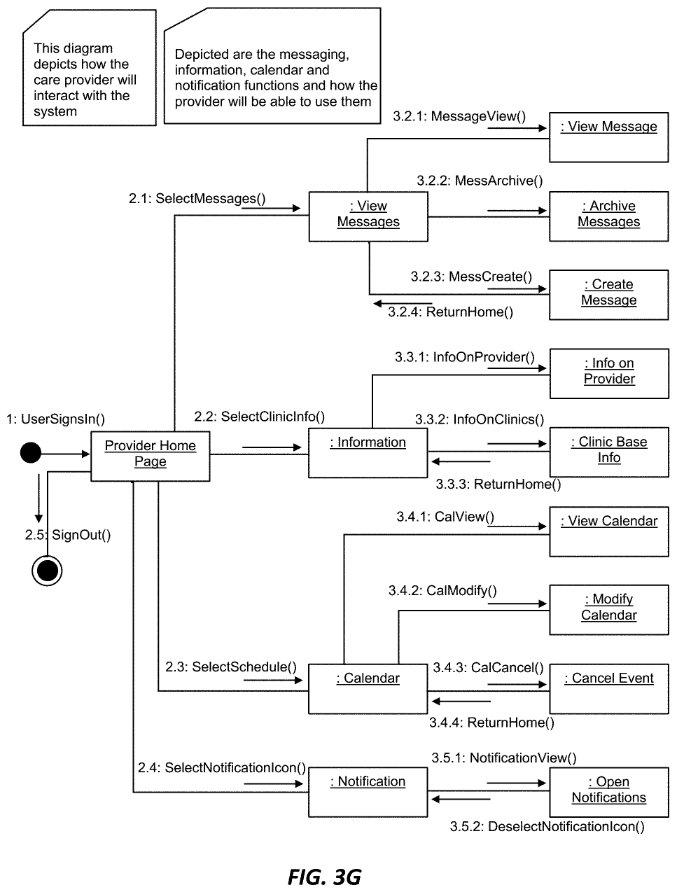

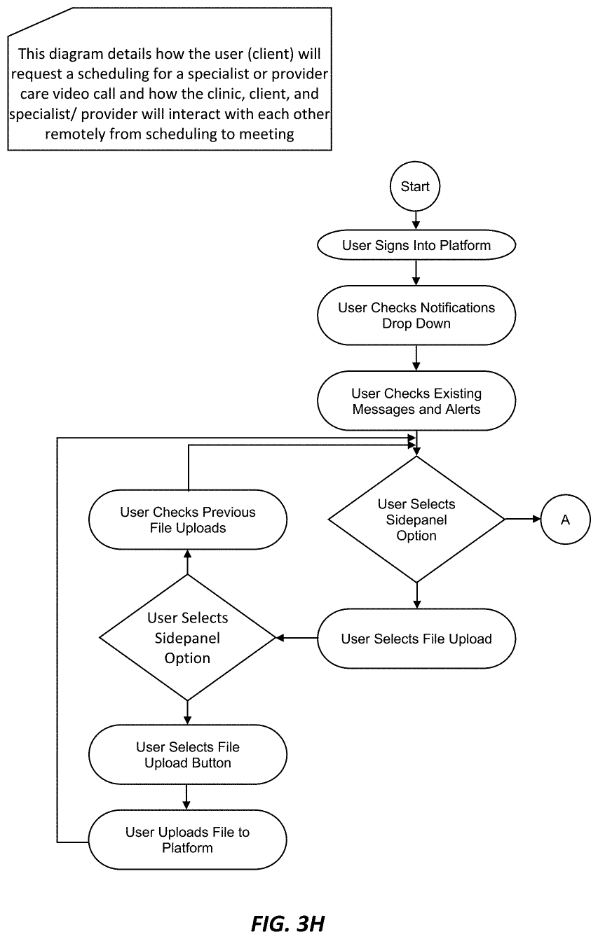

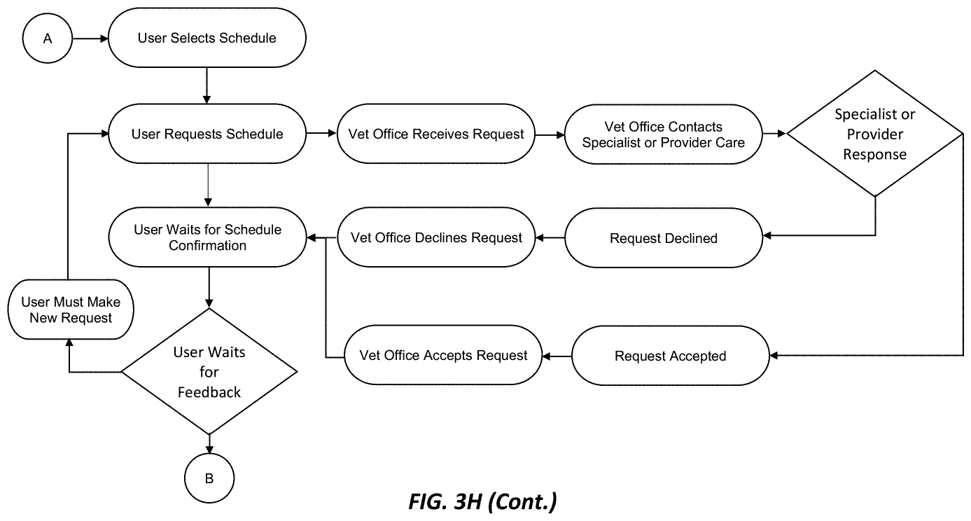

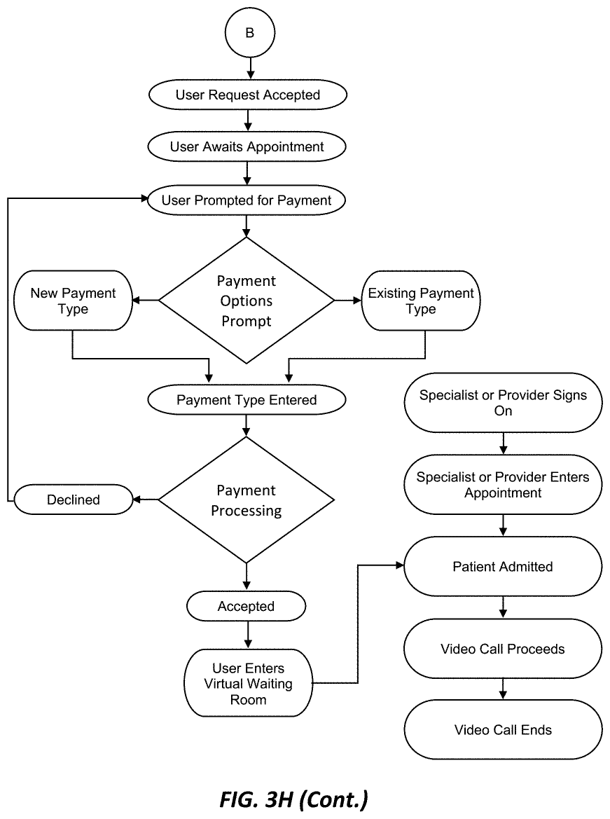

FIG. 2-3 is an embodiment of a screen 240 displayed when the My Clinic option is chosen from the menu 210. Screen 240 includes a region having details about the client's veterinary clinic, here Training VN Clinic. The screen also has a region Clinic Providers, which lists individual veterinary providers of the clinic. Selection of a provider icon causes information about the provider to be displayed.

FIG. 2-4 is an embodiment of a screen 250 displayed when the My Pets option is chosen from the menu 210. Screen 250 includes a region having details about the client's pets, here Dog, Snoopy, Horse, and Jack. In this example, the My Pets region 224 lists the pets in a table with the headings: Pet Name, Birth Info, Species, and Breed. Selection of a pet icon causes additional information about the pet to be displayed.

FIG. 2-5 is an embodiment of a screen 260 displayed when the Docs option is chosen for a pet from the My Pets screen 250. Here, the Docs option was chosen for the pet named Dog. Screen 260 the documents available from the platform 100 associated with the pet, as uploaded by a provider.

FIG. 2-6 is an embodiment of a screen 270 displayed when the Financial Records option is chosen from the menu 210. Screen 270 includes listing transaction for the client, here either All or Pending Transactions. In this example, the Pending Transactions tab is chosen, displaying a table of outstanding transaction for this client. Each pending transaction is listed with associated details, such as ID, pet Name, Amount due, and an Action to Pay. Selection of the Pay option transitions the client to an electronic pay screen.

FIG. 2-7 is an embodiment of a screen 280 displayed when the My Profile option is chosen from the menu 210. Screen 280 includes a plurality of fields associated with the client's profile. The client and view and update its information using this screen.

FIGS. 2-8 though 2-17 show embodiments of provider and/or client displays that can be generated by the platform 100.

FIG. 2-8 is a provider dashboard screen 290. From the Dashboard window, the client can make, view, and manage appointments for all of its pets, as well as enter a virtual waiting room for a virtual veterinary appointment. In this embodiment, the provider screen includes a menu portion on the left side of the main portion. The main portion can be structured to present information and functions in logical groups that enhance the ease of use by the provider. In some embodiments, the main window can include one or more regions, each region comprising a logical grouping of information and functions. Information and functions in one region can be related to information and functions in another region within the main portion. As an example, in some embodiments, selection of a function and/or information in one region can cause responsive changes to information and/or functions in another region.

In FIG. 2-8, the dashboard screen includes a Waiting Room section listing the patient logged in for an appointment with the provider. The screen also includes an Upcoming Appointment region listing the upcoming appointments for the provider. In the Waiting Room portion, there is an ADMIT option selectable by the provided to commence the appointment with the client. The Upcoming Appointments region lists the upcoming appointments for the provider. The upcoming appointments are listed in a table that includes the headings Patient Name, Provider, Reason for Visit, Date, Time, Status, and Action.

In the Upcoming Appointments region, the pet Dog is shown to have an appointment with a provider named “Doctor” on Jan. 1, 2020. Preferably, the appointment date, time, reason, and status (e.g., “new”) are also given in this region. Additionally, various Actions can be enabled in or associated with this region 222, such as EDIT, VIEW or CANCEL the appointment.

Selecting the VIEW option in FIG. 2-9 causes the display in FIG. 2-10 to be generated. This screen has regions for the Pet Detail and Pet Document associated with the pet in the pet detail, for the selected appointment. Selecting the Add Document option in FIG. 2-10 generates the display in FIG. 2-11, providing the provider with the opportunity to add a document associate with the pet and/or the appointment.

In FIG. 2-12, selecting the My Schedule menu option can bring up a screen for making, managing, and viewing appointments, such as for making the appointments shown in the Upcoming Appointments of the Dashboard screen.

FIG. 2-13 is a calendar view that enables a provider to indicate his availability for an appointment. Once a date is chosen in FIG. 2-13, the screen in FIG. 2-14 is generated. The screen enables the user to enter an availability or appointment time. The provider can apply this availability to a chosen month and/or to a chosen day of the week for the month or for multiple months.

FIG. 2-15 provides an example of a display the client can use to schedule an appointment. This display can be rendered in response to selection of the Appointments menu option in FIG. 2-1. In FIG. 2-15 the client can select a clinic for an in-person visit or virtual, which can be chosen from a pulldown list. In other embodiments, the platform 100 could recommend a clinic based on the geographic location (e.g., by zip code) of the pet or animal and, optionally, in conjunction with the particular ailment or issue of the pet or animal serving as the basis for the appointment request. In FIG. 2-15, the client can request a virtual appoint, e.g., a 15-minute appointment via an external device 10, 20, 03 30, e.g., via the Internet.

The scheduler module 118 could also be used to schedule an urgent care appointment, which again could be in-person or virtual. The emergency scheduling display of presents a series of questions soliciting client response in anticipation of a virtual appointment. Once the client responds to the questions, an urgent care appointment can be scheduled, e.g., a virtual care appointment over the Internet where the clinician and client can engage in a video chat that enables the clinician to examine the pet or animal view the camera.

FIG. 2-16 is an embodiment of provider screen that can be generated by the client module 114 of the platform 100, as an example. In the embodiment of FIG. 2-16, the provider screen includes a Calendar region that presents a calendar, wherein the dates are selectable. Choosing a date from the calendar can generate a list of appointments on the selected date. In this example, Sunday Jun. 23, 2019 is selected and there are no appointments for that provider on that date.

FIG. 2-17 is an embodiment of a display screen that can be rendered with the provider selects the My Appointments (or Appointments) menu option. This screen enables a provider to respond to a client's request for a virtual consultation by scheduling an appointment with a specialist. Here, the provider can be the clinic responding to a patient's request for a virtual consultation with a specialist.

In FIG. 2-17, a set of fields appears on the left for provider selection. The fields appear as pulldown menus in this embodiment. The fields are labeled Select Clinic (“Lincoln Memorial University”), Select Pet (“Bhavik Patel—Simba”), Select Appointment Type (e.g., “Schedule Specialty Appointment”), Select Specialist (“Mahendra Kavathlya”), and Select Other Provider (“Invite Other Provider”). In a main region of the screen is a calendar view with available appointment times for each day shown. Assuming the selections are made in the dropdown menus, certain dates and times will be selectable, depending on the availability of the patient/client and the one or more specialists involved in the consultation.

In FIGS. 2-16 and 2-17, selecting the Calendar View menu option can bring up a screen for viewing, making, and managing appointments via a calendar. Selecting a date in a calendar presented the Calendar View can cause appointments scheduled for the selected date to be displayed and/or schedule availability for the specialist/provider.

In FIGS. 2-16 and 2-17, selecting the Notifications menu option can generate a screen for viewing Notifications, e.g., from a client, an administrator, or another provider. In FIG. 2-16, selecting the My Clients menu option can generate a screen for reviewing information for the providers clients, including, in some embodiments, pet information, appointment information, contact information, notes, and so forth, in a client-by-client basis.

In FIGS. 2-16 and 217, selecting the Profile Settings menu option can generate a screen for setting up, editing, and/or managing a provider profile, including the entry of contact, clinic, and specialty information, as appropriate. Selecting the Training menu option can enable a specialist/provider to enter information associated with education, certifications, practical experience, and/or other information relevant to the specialists' expertise and qualifications.

FIGS. 3A-3H show various workflows and communications diagrams used to setup and access accounts and use the platform 100, where the functionality exists within the platform to carry out these workflows. In these workflow figures, the platform 100 may be referred to as VetNOW or the VetNOW platform. VetNOW is a trademark of Vetnow LLC.

FIG. 3A shows an embodiment of an example of a workflow diagram describing how an administrator could create a user account within the platform FIG. 1, in accordance with aspects of the inventive concept. In particular, FIG. 3 shows an example workflow of a user creation process 300 on the platform 100. In a step 301, a veterinary provider having an account on the platform 100 creates the client-user account, e.g., for a new or existing client of the provider's practice. In step 302, the client-user gives information about the user and his pets (or animals) to the provider-user. This information can be solicited by the provider via an electronic questionnaire or otherwise entered electronically by the client via one or more user interface screens, e.g., a web portal, as an example. In step 303, the client-user account is created based on the information gathered and entered in the prior steps.

In step 304, the client can receive electronic notification that its account has been created on the platform. In some embodiments, particularly if the client created the account, the veterinary care provider can receive an electronic notification of the creation of the user account. In step 306, the client-user account is registered with the platform 100. For there, the client could login to the platform 100 to take advantage of the resources enabled therethrough.

FIG. 3B shows an example of a high-level workflow 310 for user use of the platform 100, whether by provider or client. In step 311, the user signs into the platform 100 to begin a session, including any necessary authentication processes required. In step 312, in various embodiments, the platform 100 defaults the display to include a dashboard screen and a menu. For example, the platform 100 could render the display 200 of FIG. 2, with the menu portion 210 and the main portion 212 having the Dashboard window 220 displayed therein.

In step 313, the user interacts with the platform via the user interface to perform tasks, as otherwise described herein. In step 314, the user completes a task and the process moves to step 315. In step 315, if the user is not done, the process moves to step 316, where a user wants to perform another task. The process returns to step 313 where the user performs the tasks. If the user completed a task in step 314 and had no remaining tasks is step 317, the process moves to step 318, where the user logs out of the platform and ends the session.

FIG. 3C shows an example of a high-level communication diagram for user account creation and/or login to the platform 100. As indicated by arrow 1, the platform 100 renders a sign-in page, an example of which is shown in FIG. 3C-1. If the user is recognized, the user can login, indicated by arrow 2.1. If the user is not recognized, the user receives a message to that effect indicated by arrow 2.2. The user can choose to create an account, indicated by arrow 2.3 and enter the platform 100, indicated by arrow 3.

FIG. 3D shows an example of a high-level communication diagram for how a client-user interacts with the platform 100, in various embodiments. After signing in, arrow 1, the platform 100 renders the user's home page, such as screen 200 with dashboard window 220. Using the menu portion 210, the client can navigate to a number of different options for tasks and/or information.

Selecting the Urgent Care link option causes the platform to responsively transition to the Urgent Care window, indicated by arrow 2.1. From the Urgent care window, the client can select from a plurality of different options. For example, the client can chose a CareRequest option, indicated by arrow 3.1.1, that enables to the client to input information to request immediate care for a pet or other animal.

FIG. 3E shows an example of a high-level communication diagram for how a client user requests urgent care within the platform 100.

FIG. 3F shows an example of a high-level communication diagram for how a clinic (as a provider) interacts with the platform 100.

FIG. 3G shows an example of a high-level communication diagram for how a provider user, e.g., a clinician, interacts with the platform 100, including messaging, notification and calendar functions.

FIG. 3H shows an example of a high-level workflow diagram for conduct of a video or virtual appointment using the platform 100.

FIGS. 4-1 and 4-2 collectively provide an example of a class diagram that could be used to implement some of the functions of the modules of the platform 100 in computer program code.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can combined in any given way.

APPENDIX A

| Specialty | College | Suffix/Initials |
|---|---|---|
| Anesthesia | American College of Veterinary | DACVAA/DACVA |
| | Anesthesia and Analgesia | Dip |
| Behavior | American College of Veterinary | DACVB |
| | Behaviorists | |
| Dentistry | American Veterinary Dental | DAVDC |
| Small Animal ONLY | College | |
| Dermatology | American College of Veterinary | DACVD |
| | Dermatology | |
| Emergency and Critical Care | American College of Veterinary | DACVECC - SA |
| Small Animal | Emergency and Critical Care | DACVECC - LA |
| Large Animal | | |
| Internal Medicine | American College of Veterinary | DACVIM - SA |
| Small Animal | Internal Medicine | DACVIM - LA |
| Large Animal | | |
| Internal Medicine - Cardiology | American College of Veterinary | DACVIM (Cardiology) |
| | Internal Medicine | |
| Internal Medicine - Neurology | American College of Veterinary | DACVIM (Neurology) |
| | Internal Medicine | |
| Internal Medicine - Oncology | American College of Veterinary | DACVIM (Oncology) |
| | Internal Medicine | |
| Nutrition | American College of Veterinary | DACVN |
| | Nutrition | |
| Ophthamology | American College of Veterinary | DACVO |
| | Ophthamologists | |
| Pathology | American College of Veterinary | DACVP |
| | Pathology | |
| Sports Medicine and | American College of Veterinary | DACVSMR (Canine) |
| Rehabilitation | Sports Medicine and | DACVSMR (Equine) |
| Canine | Rehabilitation | |
| Equine | | |
| Surgery | American College of Veterinary | DACVS - SA |
| Small Animal | Surgery | DACVS - LA |
| Large Animal | | |
| Theriogenology | American College of | DACT |
| Small Animal | Theriogenologists | |
| Equine/Large Animal | | |
| Exotics - Zoo | American College of Zoological | DACZM |
| | Medicine | |
| Exotics - Companion | American Board of Veterinary | DABVP (ECM) |
| | Practitioners | DABVP (Avian) |
| | Exotic Companion | DABVP (Reptile and Amphibian) |
| | Mammal | |
| | Avian | |
| | Reptile and Amphibian | |
| Anesthesia | European College of Veterinary | Dip ECVAA |
| | Anesthesia and Analgesia | |
| Behavioural Medicine | European College of Animal | Dip ECAWBM (BM) |
| | Welfare and Behavioural | |
| | Medicine | |
| Dentistry | European Veterinary Dental | Dip EVDC |
| Small Animal ONLY | College | |
| Dermatology | European College of Veterinary | Dip ECVD |
| | Dermatology | |
| Emergency and Critical Care | European College of Veterinary | Dip ECVECC |
| | Emergency and Critical Care | |
| Internal Medicine - Equine | European College of Equine | Dip ECEIM |
| | Internal Medicine | |
| Internal Medicine - Companion | European College of Veterinary | Dip ECVIM-CA |
| Animal | Internal Medicine - Companion | |
| | Animal | |
| Internal Medicine - Cardiology | European College of Veterinary | Dip ECVIM-CA (Cardiology) |
| | Internal Medicine - Companion | |
| | Animal | |
| Internal Medicine - Oncology | European College of Veterinary | Dip ECVIM-CA (Oncology) |
| | Internal Medicine - Companion | |
| | Animal | |
| Neurology | European College of Veterinary | Dip ECVN |
| | Neurology | |
| Nutrition | European College of Veterinary | Dip ECVCN |
| | and Comparative Nutrition | |
| Ophthamology | European College of Veterinary | Dip ECVO |
| | Ophthamologists | |
| Clinical Pathology | European College of Clinical | Dip ECVCP |
| | Pathology | |
| Sports Medicine and | European College of Veterinary | Dip ECVSMR (Canine) |
| Rehabilitation | Sports Medicine and | Dip ECVSMR (Equine) |
| Canine | Rehabilitation | |
| Equine | | |
| Surgery | European College of Veterinary | Dip ECVS (Small Animal) |
| Small Animal | Surgery | Dip ECVS (Large Animal) |
| Large Animal | | |
| Reproduction | European College of Animal | Dip ECAR |
| | Reproduction | |

What we claim is:

1. A virtual care veterinary system, comprising:
one or more processors coupled to one or more data storage devices including computer program logic executable by the one or more processors to provide a user-interactive computer platform accessible via one or more communications networks,
wherein the program logic comprises:
a provider module including program code executable to electronically set up a provider profile representing a veterinary clinic, the provider profile including an identification of each veterinarian in the veterinary clinic's practice;
generate a provider dashboard interface including provider-selectable options for interacting with a plurality of clients and a plurality of veterinary specialists via a user interface established by the platform; and
a client module including program code executable to register a plurality of clients with provider profile in the platform, including:
set up and maintain a client profile for each of the plurality of clients, the client profile including an identification of at least one pet and/or animal; and
generate a client dashboard interface for each client, including client-selectable options for interacting with a veterinary care provider via a user interface established by the platform;
a specialists module including program code executable to register a plurality of specialists with the provider profile in the platform, including:
set up and maintain a specialist profile for each of a plurality of veterinarian specialists, each specialist profile including at least one area of specialty and electronic contact information; and
a medical resources module including program code executable to establish virtual sessions between the provider, at least one client, and/or at least one specialist via a user interface established via the platform.

2. The system of claim 1, wherein the medical resources module is further executable to establish a real-time, virtual collaboration session between a veterinarian and at least one specialist to diagnose and/or treat a pet and/or animal via the platform.

3. The system of claim 1, wherein the medical resources module is further executable to share historical and/or real-time diagnostic and/or treatment information associated with the pet and/or animal during the real-time, virtual collaboration session.

4. The system of claim 1, wherein the medical resources module is further executable to establish a real-time, virtual appointment between the provider and the client to diagnose and/or treat a pet and/or animal from the client profile via the platform

5. The system of claim 1, further comprising:
a scheduler module including program code executable to enable a user having a client profile to login to the platform and to provide a user interface to enable to the user to make, change, and cancel appointments with a veterinarian of the provider.

6. The system of claim 5, wherein the scheduler module is further executable to:
create a virtual waiting room where the client waits for a scheduled appointment after login to the platform;
automatically generate an electronic notification to the veterinarian and/or specialist indicating that the client is in the virtual waiting room; and
enable the veterinarian and/or specialist to electronically admit the client into the appointment.

7. The system of claim 1, further comprising:
a notifier module including program code executable to send electronic notifications to the provider, veterinarian, specialist, and/or client associated with the healthcare of the client's pet and/or animal, including information about appointments, diagnoses, and/or treatments associated with the pet and/or animal.

8. The system of claim 7, wherein the notifications is provided via at least one of text message, initiation of a chat session, a pager message, an email, and/or an automated call.

9. The system of claim 7, wherein the notifier module is further executable to:
generate and send the provider, veterinarian, and/or specialist an appointment request notification in response to a client's electronic request for an appointment.

10. The system of claim 9, wherein the appointment request notification is provided via at least one of text message, initiation of a chat session, a pager message, an email, and/or an automated call.

11. A virtual care veterinary method, comprising:
providing one or more processors coupled to one or more data storage devices including computer program logic executable by the one or more processors to provide a user-interactive computer platform accessible via one or more communications networks; and
executing the program logic, including providing at least one user interface and electronically:
setting up a provider profile representing a veterinary clinic, the provider profile including an identification of each veterinarian in the veterinary clinic's practice;
generating a provider dashboard interface including provider-selectable options for interacting with a plurality of clients and a plurality of veterinary specialists via a user interface established by the platform;
setting up and maintaining a client profile for each of the plurality of clients, the client profile including an identification of at least one pet and/or animal;
generating a client dashboard interface for each client, including client-selectable options for interacting with a veterinary care provider via a user interface established by the platform;
registering a plurality of specialists with the provider profile in the platform, including:
setting up and maintaining a specialist profile for each of a plurality of veterinarian specialists, each specialist profile including at least one area of specialty and electronic contact information; and
establishing virtual sessions between the provider, at least one client, and/or at least one specialist via a user interface established via the platform.

12. The method of claim 11, further comprising establishing a real-time, virtual collaboration session between a veterinarian and at least one specialist to diagnose and/or treat a pet and/or animal via the platform.

13. The method of claim 11, further comprising electronically sharing historical and/or real-time diagnostic and/or treatment information associated with the pet and/or animal during the real-time, virtual collaboration session.

14. The method of claim 11, further comprising establishing a real-time, virtual appointment between the provider and the client to diagnose and/or treat a pet and/or animal from the client profile via the platform

15. The method of claim 11, further comprising:
enabling a user having a client profile to login to the platform and to provide a user interface to enable to the user to make, change, and cancel appointments with a veterinarian of the provider.

16. The method of claim 15, further comprising:
creating a virtual waiting room where the client waits for a scheduled appointment after login to the platform;
automatically generating an electronic notification to the veterinarian and/or specialist indicating that the client is in the virtual waiting room; and
enabling the veterinarian and/or specialist to electronically admit the client into the appointment.

17. The method of claim 11, further comprising:
automatically generating and sending electronic notifications to the provider, veterinarian, specialist, and/or client associated with the healthcare of the client's pet and/or animal, including information about appointments, diagnoses, and/or treatments associated with the pet and/or animal.

18. The method of claim 17, wherein the notifications are provided via at least one of text message, initiation of a chat session, a pager message, an email, and/or an automated call.

19. The method of claim 17, further comprising generating and sending an appointment request notification to the provider, veterinarian, and/or specialist in response of a client's electronic request for an appointment.

20. The method of claim 19, wherein the appointment request notification is provided via at least one of text message, initiation of a chat session, a pager message, an email, and/or an automated call.
